(19) United States
(12) Patent Application Publication
(10) Pub. No.: US 2021/0086680 A1
(43) Pub. Date: Mar. 25, 2021

(54) Tailgate Cooker Assembly

(71) Applicant: Daniel Kyle, Leehigh, FL (US)

(72) Inventor: Daniel Kyle, Leehigh, FL (US)

(21) Appl. No.: 16/582,627

(22) Filed: Sep. 25, 2019

(51) Int. Cl. B60N 3/16; A47J 37/07; B62D 33/023; H05B 6/12

(52) U.S. Cl. CPC B60N 3/16; A47J 37/07; A47J 2037/0777; H05B 6/12; B62D 33/023

(57) ABSTRACT

A tailgate cooker assembly for cooking in a remote location includes a tailgate that is mountable to a bed of a cargo vehicle for opening and closing the bed. An induction stove is recessed into the tailgate. The induction stove lies on a horizontal plane when the tailgate is positioned in the open position for cooking. An inverter is coupled to the cargo vehicle and the induction stove receives electrical power from the inverter. A lid is hingedly coupled to the tailgate and the lid covers the induction stove when the lid is positioned in a closed position. A plurality of light emitters is each of the light emitters is coupled to the lid to emit light outwardly from the lid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooker devices and more particularly pertains to a new cooker device for cooking in a remote location.

### (2) Description of Related Art Including Information Disclosed Under 37 CFR 1.97 and 1.98

The prior art relates to cooker devices.

### BRIEF SUMMARY OF THE INVENTION

An embodiment of the disclosure meets the needs presented above by generally comprising a tailgate that is mountable to a bed of a cargo vehicle for opening and closing the bed. An induction stove is recessed into the tailgate. The induction stove lies on a horizontal plane when the tailgate is positioned in the open position for cooking. An inverter is coupled to the cargo vehicle and the induction stove receives electrical power from the inverter. A lid is hingedly coupled to the tailgate and the lid covers the induction stove when the lid is positioned in a closed position. A plurality of light emitters is each of the light emitters is coupled to the lid to emit light outwardly from the lid.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a tailgate cooker assembly according to an embodiment of the disclosure.

FIG. 2 is a perspective view of an embodiment of the disclosure showing a lid in a closed position.

FIG. 3 is a phantom in-use view of an embodiment of the disclosure.

FIG. 4 is a top view of an embodiment of the disclosure.

FIG. 5 is a cross sectional view taken along line 5-5 of FIG. 4 of an embodiment of the disclosure.

### DETAILED DESCRIPTION OF THE INVENTION

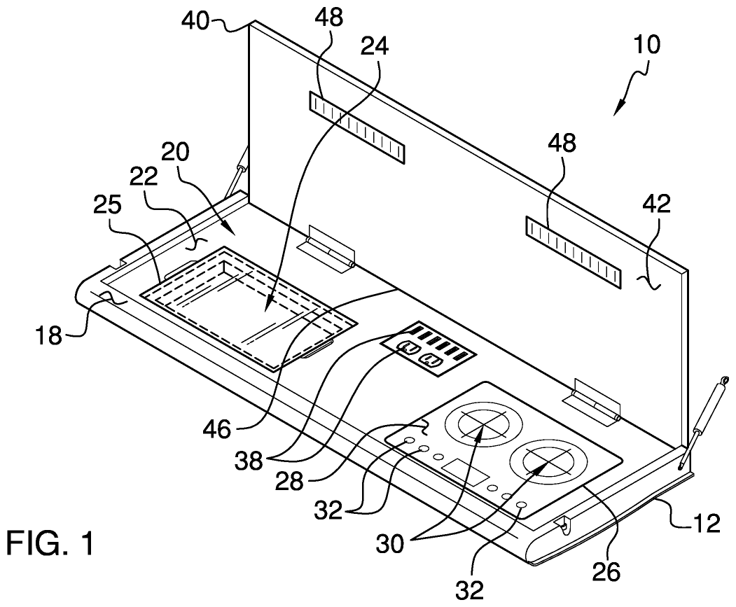

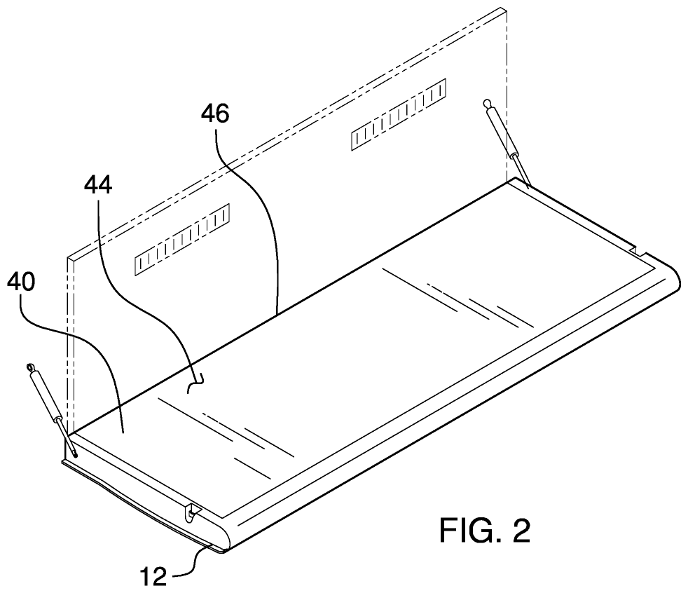

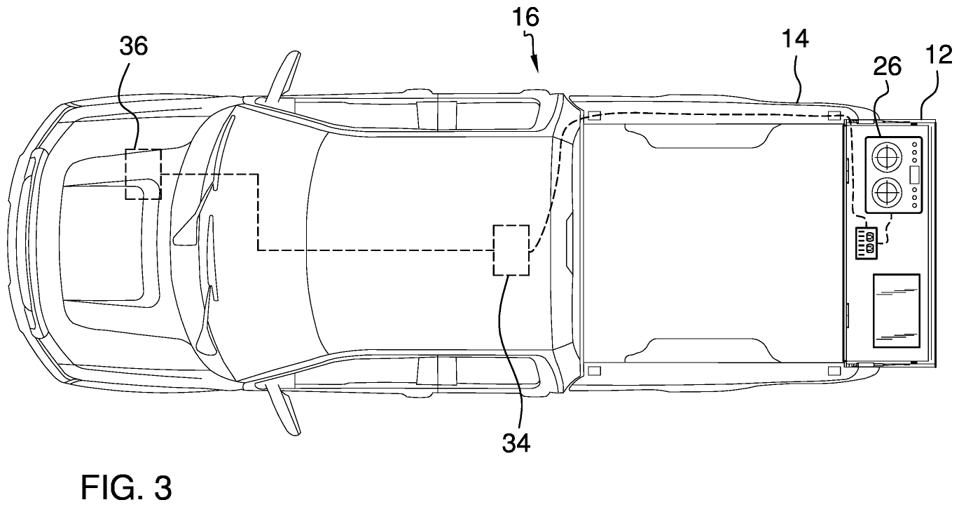

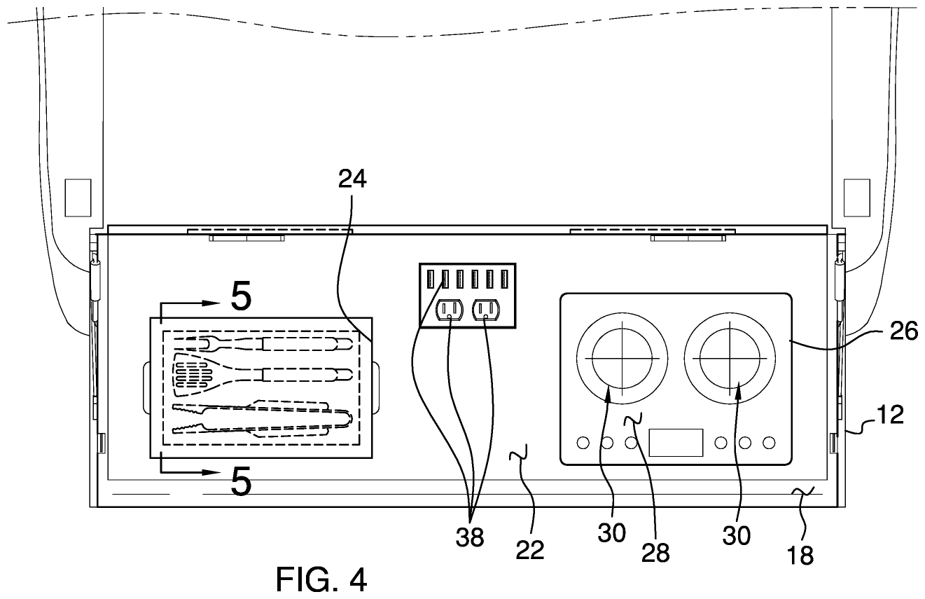

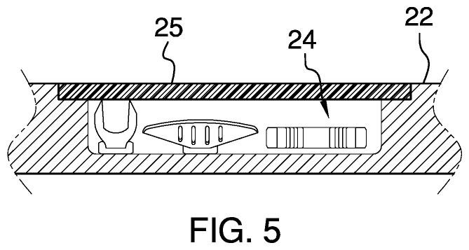

With reference now to the drawings, and in particular to FIGS. 1 through 5 thereof, a new cooker device embodying the principles and concepts of an embodiment of the disclosure and generally designated by the reference numeral 10 will be described.

As best illustrated in FIGS. 1 through 5, the tailgate cooker assembly 10 generally comprises a tailgate 12 is mountable to a bed 14 of a cargo vehicle 16 for opening and closing the bed 14. The cargo vehicle 16 may be a pickup or any other motorized vehicle that has a tailgate. The tailgate 12 has a first surface 18 and the first surface 18 lies on a horizontal plane when the tailgate 12 is positioned in an open position. The first surface 18 has a recess 20 therein the recess 20 has a lower bounding surface 22. The lower bounding surface 22 has a storage well 24 extending into an interior of the tailgate 12. A cover 25 is positionable over the storage well 24.

An induction stove 26 is recessed into the tailgate 12. The induction stove 26 lies on a horizontal plane when the tailgate 12 is positioned in the open position. In this way food items placed can be placed on the induction stove 26 for cooking. The induction stove 26 has a top surface 28 that is aligned with the lower bounding surface 22 of the recess 20 in first surface 18 of the tailgate 12. The top surface 28 has at least a pair of cooking areas 30 and each of the cooking areas 30 is discretely heated when the induction stove 26 is turned on. The induction stove 26 includes a plurality of control buttons 32 that each controls the pair of cooking areas 30.

An inverter 34 is provided and the inverter 34 is electrically coupled to the cargo vehicle 16. The inverter 34 is electrically coupled to an electrical system 36 of the cargo vehicle 16. The induction stove 26 is electrically coupled to the inverter 34 such that the induction stove 26 receives electrical power from the inverter 34. The inverter 34 may be an electronic inverter for converting DC voltage into AC voltage.

A plurality of power ports 38 is provided and each of the power ports 38 is recessed into the tailgate 12. Each of the power ports 38 can have an electronic device plugged therein for charging or powering the electronic device. Each of the power ports 38 is electrically coupled to the inverter 34 such that each of the power ports 38 receives electrical power from the inverter 34. Additionally, each of the power ports 38 is positioned on the lower bounding surface 22 of the recess 20 in the first surface 18 of the tailgate 12. The plurality of power ports 38 may include a set of female electrical outlets and a set of USB ports.

A lid 40 is hingedly coupled to the tailgate 12 and the lid 40 covers the induction stove 26 when the lid 40 is positioned in a closed position. The lid 40 has a primary surface 42, a secondary surface 44 and a rear edge 46. The rear edge 46 is hingedly coupled to the first surface 18 of the tailgate 12. The primary surface 42 of the lid 40 rests on the first surface 18 of the tailgate 12 having the lid 40 being positioned in the recess 20 when the lid 40 is positioned in a closed position. The secondary surface 44 lies on a plane that is coplanar with the first surface 18 of the tailgate 12 when the lid 40 is in the closed position.

A plurality of light emitters 48 is provided and each of the light emitters 48 is coupled to the lid 40 to emit light outwardly from the lid 40. Each of the light emitters 48 is positioned on the primary surface 42 of the lid 40. Additionally, each of the light emitters 48 is distally positioned with respect to the rear edge 46 of the lid 40. The light emitters 48 illuminate the first surface 18 of the tailgate 12 when the light emitters 48 are turned on. Each of the light emitters 48 is electrically coupled to the inverter 34 and each of the light emitters 48 may comprise an LED or the like.

In use, the tailgate 12 is positioned in the open position and the lid 40 is positioned in the open position. In this way the induction stove 26 is exposed for cooking food items during camping, tailgate 12 parties or any other occasion when food items are to be cooked in a remote location. Additionally, electronic devices can be plugged into the power ports 38 for charging or powering the electronic devices. The induction stove 26 is turned on to cook the food items. The induction stove 26 is turned off and the lid 40 is closed prior to closing the tailgate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A tailgate cooker assembly being configured to be mounted on a bed of a cargo vehicle for cooking in remote locations, said assembly comprising:
a tailgate being mountable to a bed of a cargo vehicle for opening and closing the bed;
an induction stove being recessed into said tailgate, said induction stove lying on a horizontal plane when said tailgate is positioned in said open position wherein said induction stove is configured to have food items placed thereon for cooking;
an inverter being coupled to the cargo vehicle, said inverter being electrically coupled to an electrical system of the cargo vehicle, said induction stove being electrically coupled to said inverter such that said induction stove receives electrical power from said inverter;
a lid being hingedly coupled to said tailgate, said lid covering said induction stove when said lid is positioned in a closed position; and
a plurality of light emitters, each of said light emitters being coupled to said lid wherein each of said light emitters is configured to emit light outwardly from said lid.

2. The assembly according to claim 1, wherein said tailgate has a first surface, said first surface lying on a horizontal plane when said tailgate is positioned in an open position, said first surface having a recess therein, said recess having a storage well extending into an interior of said tailgate, said recess having a lower bounding surface.

3. The assembly according to claim 2, wherein said induction stove has a top surface being aligned with said lower bounding surface of said recess in first surface of said tailgate, said top surface having at least a pair of cooking areas, each of said cooking areas being discretely heated when said induction stove is turned on.

4. The assembly according to claim 2, further comprising a plurality of power ports, each of said power ports being recessed into said tailgate wherein each of said power ports is configured to have an electronic device plugged therein, each of said power ports being electrically coupled to said inverter such that each of said power ports receives electrical power from said inverter, each of said power ports being positioned on said lower bounding surface of said recess in said first surface of said tailgate.

5. The assembly according to claim 2, wherein said lid has a primary surface, a secondary surface and a rear edge, said rear edge being hingedly coupled to said first surface of said tailgate, said primary surface resting on said first surface of said tailgate having said lid being positioned in said recess when said lid is positioned in a closed position, said secondary surface lying on a plane being coplanar with said first surface of said tailgate when said lid is in said closed position.

6. The assembly according to claim 5, wherein each of said light emitters is positioned on said primary surface of said lid, each of said light emitters being distally positioned with respect to said rear edge of said lid, each of said light emitters being electrically coupled to said inverter.

7. A tailgate cooker assembly being configured to be mounted on a bed of a cargo vehicle for cooking in remote locations, said assembly comprising:
a tailgate being mountable to a bed of a cargo vehicle for opening and closing the bed, said tailgate having a first surface, said first surface lying on a horizontal plane when said tailgate is positioned in an open position, said first surface having a recess therein, said recess having a storage well extending into an interior of said tailgate, said recess having a lower bounding surface;
an induction stove being recessed into said tailgate, said induction stove lying on a horizontal plane when said tailgate is positioned in said open position wherein said induction stove is configured to have food items placed thereon for cooking, said induction stove having a top surface being aligned with said lower bounding surface of said recess in first surface of said tailgate, said top surface having at least a pair of cooking areas, each of said cooking areas being discretely heated when said induction stove is turned on;
an inverter being coupled to the cargo vehicle, said inverter being electrically coupled to an electrical system of the cargo vehicle, said induction stove being electrically coupled to said inverter such that said induction stove receives electrical power from said inverter;
a plurality of power ports, each of said power ports being recessed into said tailgate wherein each of said power ports is configured to have an electronic device plugged therein, each of said power ports being electrically coupled to said inverter such that each of said power ports receives electrical power from said inverter, each of said power ports being positioned on said lower bounding surface of said recess in said first surface of said tailgate;
a lid being hingedly coupled to said tailgate, said lid covering said induction stove when said lid is positioned in a closed position, said lid having a primary surface, a secondary surface and a rear edge, said rear edge being hingedly coupled to said first surface of said tailgate, said primary surface resting on said first surface of said tailgate having said lid being positioned in said recess when said lid is positioned in a closed position, said secondary surface lying on a plane being coplanar with said first surface of said tailgate when said lid is in said closed position; and
a plurality of light emitters, each of said light emitters being coupled to said lid wherein each of said light emitters is configured to emit light outwardly from said lid, each of said light emitters being positioned on said primary surface of said lid, each of said light emitters being distally positioned with respect to said rear edge of said lid, each of said light emitters being electrically coupled to said inverter.
